(19) United States
(12) Patent Application Publication
(10) Pub. No.: US 2025/0077180 A1
(43) Pub. Date: Mar. 6, 2025

(54) BIT-PARALLEL DIGITAL COMPUTE-IN-MEMORY MACRO AND ASSOCIATED METHOD

(71) Applicant: MEDIATEK INC., Hsin-Chu (TW)

(72) Inventors: Ming-Hung Lin, Hsinchu City (TW); Ming-En Shih, Hsinchu City (TW); Shih-Wei Hsieh, Hsinchu City (TW); Ping-Yuan Tsai, Hsinchu City (TW); You-Yu Nian, Hsinchu City (TW); Pei-Kuei Tsung, Hsinchu City (TW); Jen-Wei Liang, Hsinchu City (TW); Shu-Hsin Chang, Hsinchu City (TW); En-Jui Chang, Hsinchu City (TW); Chih-Wei Chen, Hsinchu City (TW); Po-Hua Huang, Hsinchu City (TW); Chung-Lun Huang, Hsinchu City (TW)

(73) Assignee: MEDIATEK INC., Hsin-Chu (TW)

(21) Appl. No.: 18/820,312

(22) Filed: Aug. 30, 2024

Related U.S. Application Data
(60) Provisional application No. 63/536,081, filed on Sep. 1, 2023.

(51) Int. Cl. G06F 7/505; G06F 7/57

(52) U.S. Cl. CPC G06F 7/505; G06F 7/57

(57) ABSTRACT

A digital compute-in-memory (DCIM) macro includes a memory cell array and an arithmetic logic unit (ALU). The memory cell array stores weight data of a neural network. The ALU receives parallel bits of a same input channel in an activation input, and generates a convolution computation output of the parallel bits and target weight data in the memory cell array.

### CROSS REFERENCE TO RELATED APPLICATIONS

This application claims the benefit of U.S. Provisional Application No. 63/536,081, filed on Sep. 1, 2023. The content of the application is incorporated herein by reference.

### BACKGROUND

The present invention relates to a compute-in-memory (CIM) design, and more particularly, to a bit-parallel digital compute-in-memory (DCIM) macro and an associated method.

Machine learning (or deep learning) is the ability of a computing device to progressively improve performance of a particular task. For example, machine learning algorithms can use results from processing known data to train a computing device to process new data with a higher degree of accuracy. Neural networks are a framework in which machine learning algorithms may be implemented. A neural network is modeled with a plurality of nodes. Each node receives input signals from preceding nodes and generates an output that becomes an input signal to succeeding nodes. The nodes are organized in sequential layers such that, in a first processing stage, nodes of a first layer receive input data from an external source and generate an output that is provided to every node in a second layer. In a next processing stage, nodes of the second layer receive the outputs of each node in the first layer, and generate further outputs to be provided to every node in a third layer as the nodes in the first layer receive and process new external inputs, and so on in subsequent processing stages. Within each node, each input signal is uniquely weighted by multiplying the input signal by an associated weight. The products corresponding to the weighted input signals are summed to generate a node output. These operations performed at each node are known as a multiply-accumulate (MAC) operation. Digital compute-in-memory (DCIM) has advantages of performing robust and efficient MAC operations, compared to analog CIM solutions.

The traditional bit-serial DCIM has many drawbacks. For example, to achieve the same effective computation as a normal non-DCIM convolution design, multiple sets of higher channel bit-serial DCIMs are required. However, multiple sets of DCIMs cause complex circuitry designed around these DCIMs. In addition, higher channel bit-serial DCIMs cause low MAC utilization in the low-dimensional channel neural network. Furthermore, the bit-serial DCIM is designed to process a fixed amount of weight data and activation data. When the bit-serial DCIM is used to deal with depthwise convolution or 1×1 convolution, the efficiency is greatly reduced.

### SUMMARY

One of the objectives of the claimed invention is to provide a bit-parallel digital compute-in-memory (DCIM) macro and an associated method.

According to a first aspect of the present invention, an exemplary digital compute-in-memory (DCIM) macro is disclosed. The exemplary DCIM macro includes a memory cell array and an arithmetic logic unit (ALU). The memory cell array is configured to store weight data of a neural network. The ALU is configured to receive parallel bits of a same input channel in an activation input, and generate a convolution computation output of the parallel bits and target weight data in the memory cell array.

According to a second aspect of the present invention, an exemplary DCIM method is disclosed. The exemplary DCIM includes: storing weight data of a neural network into a memory cell array; receiving parallel bits of a same input channel in an activation input; and generating a convolution computation output of the parallel bits and target weight data in the memory cell array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a bit-parallel DCIM macro according to an embodiment of the present invention.

FIG. 2 is a diagram illustrating a bit-parallel DCIM macro design according to an embodiment t of the present invention.

FIG. 3 is a diagram illustrating pipelined processing of three 4-bit parallel-bit subsets according to an embodiment of the present invention.

FIG. 4 is a diagram illustrating different cell output selection cases according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

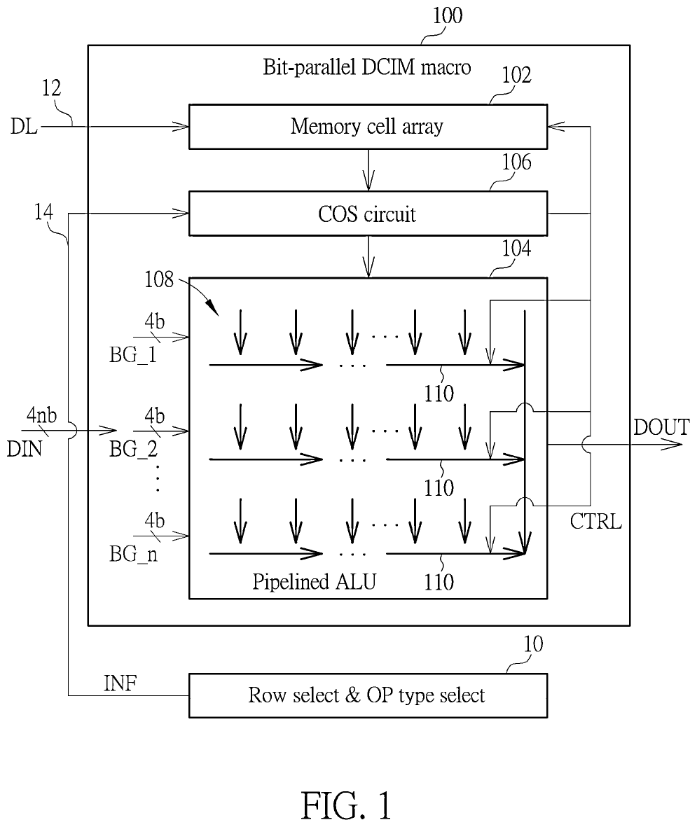

FIG. 1 is a diagram illustrating a bit-parallel DCIM macro according to an embodiment of the present invention. The bit-parallel DCIM macro 100 includes a memory cell array 102, a pipelined arithmetic logic unit (ALU) 104, and a cell output selection (COS) circuit 106. The memory cell array 102 may include a plurality of static random access memory (SRAM) cells, and is configured to store weight data of a neural network (e.g., convolutional neural network (CNN)). For example, the memory cell array 102 may be used to store weights of one or more layers of a CNN model. In some embodiments of the present invention, the memory cell array 102 may have N rows that are configured to store weight data of the neural network in a single weight data download session DL, where N may be a positive integer not smaller than two (i.e., N≥2). For example, the memory cell array 102 may have 18 rows (N=18), and may communicate with an external memory (e.g., dynamic random access memory (DRAM)) through a memory interface 12. Hence, the memory cell array 102 can load (or reload) weight data of the neural network from the external memory (e.g., DRAM) in the single weight data download session DL. However, this is for illustrative purposes only, and is not meant to be a limitation of the present invention. In practice, the proposed bit-parallel DCIM macro design has no limitations on implementation of the memory cell array 102.

In this embodiment, the proposed bit-parallel DCIM macro design has an internal ALU with pipeline architecture. The pipelined ALU 104 is a digital circuit configured to perform in-memory computing (particularly, in-memory MAC operations) upon activation data and weight data in a pipeline fashion. Specifically, the pipelined ALU 104 is configured to receive the activation data through a parallel interface in which multiple bits are sent on several wires at once. As shown in FIG. 1, the pipelined ALU 104 receives one activation data DIN (which is a parallel input with parallel 4n bits belonging to a same input channel of an activation input), and generates a convolution computation output of the activation data DIN (which is a parallel input with parallel 4n bits belonging to a same input channel of the activation input) and target weight data selected from the memory cell array 102. The convolution computation output may be a partial sum. Hence, the convolution output DOUT generated from the bit-parallel DCIM macro 100 may be generated from accumulating a plurality of partial sums though an adder tree circuit 108 of the pipelined ALU 104. It should be noted that the pipelined ALU 104 includes the adder tree circuit 108, and may also include other digital circuits (not shown) to achieve its designated functions.

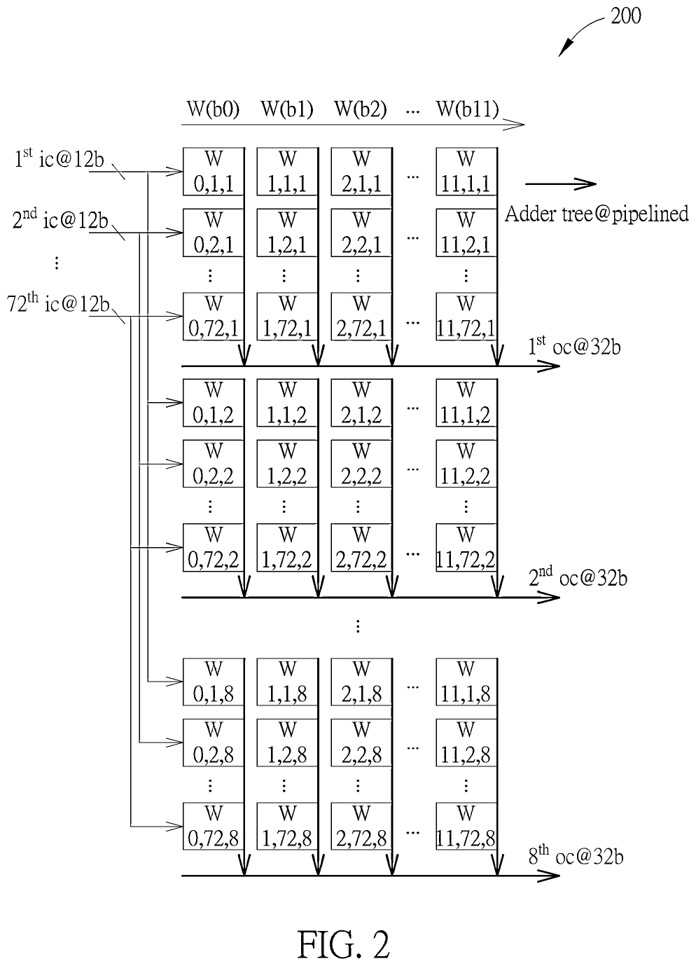

In this embodiment, one 12-bit pixel (i.e., n=3) may be received by the pipelined ALU 104 at a time, and one weight W to be multiplied with the 12-bit pixel may be a 12-bit weight with bits b0-b11. FIG. 2 is a diagram illustrating a bit-parallel DCIM macro design according to an embodiment t of the present invention. The design of the bit-parallel DCIM macro 200 is based on the structure of the bit-parallel DCIM macro 100 shown in FIG. 1. In this embodiment, the bit-parallel DCIM macro 200 may be a 72 (3×3×8) input channel (ic)/8 output channel (oc)/576 MAC DCIM macro, and the memory cell array 102 may have 24 rows. A 12-bit activation data XIN[i] of one input channel i is multiplied with a 12-bit weight W[i,j] of an output channel j. For example, a 12-bit weight W[i,j] consists of bits (b0, b1, b2, . . . , b11)=(W_{0,i,j}, W_{1,i,j}, W_{2,i,j}, . . . , W_{11,i,j}). The convolution output NOUT[j] of each output channel j has 32 bits, and the convolution computation may be expressed using the following formula.

NOUT[j]=Σᵢ₌₁⁷²XIN[i]*W[i,j], where i=1˜72 and j=1˜8 (1)

If one convolution computation output (partial sum) XIN[i] *W[i,j] is calculated in one step, the required processing time is long. To address this issue, the pipelined ALU 104 performs in-memory computing (particularly, in-memory MAC operations) upon activation data and weight data in a pipeline fashion. As shown in FIG. 1, the pipelined ALU 104 converts the activation data DIN (which is a parallel input with parallel 4n bits belonging to a same input channel of the activation input) received from a parallel interface into a plurality of parallel-bit subsets BG_1, BG_2, . . . , BG_n. For example, each of the parallel-bit subsets BG_1-BG_n has 4 bits. Hence, the pipelined ALU 104 can split the 12-bit activation data into three 4-bit parallel-bit subsets BG_1, BG_2, and BN_n (n=3). The pipelined ALU 104 generates the convolution computation output (partial sum) XIN[i] *W[i,j] by processing three 4-bit parallel-bit subsets BG_1, BG_2, and BN_n (n=3) independently. In other words, processing of the 4-bit parallel-bit subsets BG_1, BG_2, and BN_n can overlap in the time domain.

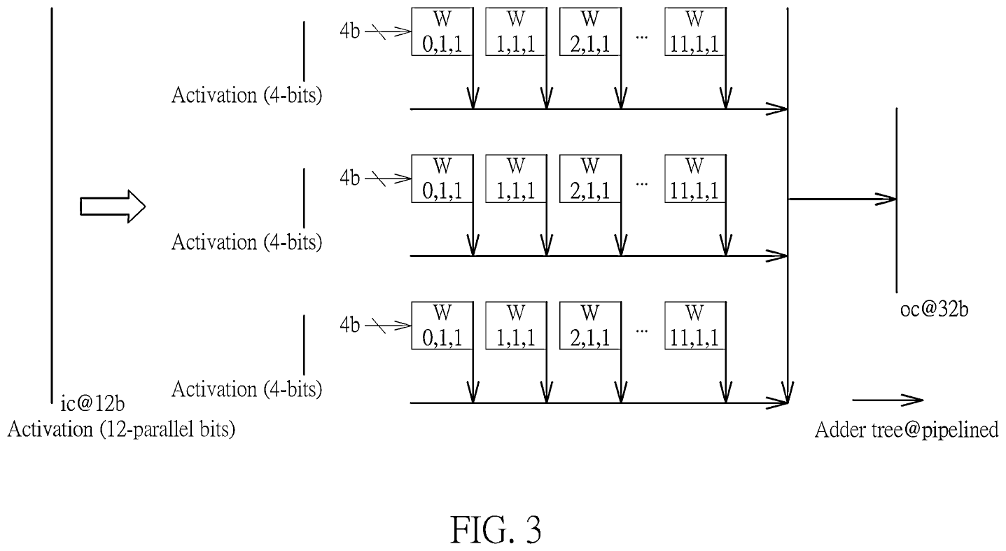

FIG. 3 is a diagram illustrating pipelined processing of three 4-bit parallel-bit subsets according to an embodiment of the present invention. The 12-bit activation data (e.g., 12-bit R/G/B pixel) is evenly split into three 4-bit parallel-bit subsets, and each of the 4-bit parallel-bit subsets will be processed independently along with the same 12-bit weight (e.g., W[1,1] consisting of bits (W_{0,1,1}, W_{1,1,1}, W_{2,1,1}, . . . , W_{11,1,1})). The resulting results obtained from processing three 4-bit parallel-bit subsets and the 12-bit weight will be added together by the adder tree circuit 108. This approach offers several benefits in terms of timing and efficiency. For example, by splitting the 12-bit parallel input into smaller parallel-bit subsets, the subsequent computations can be pipelined in a sub-parallel manner. This means that while one of the 4-bit parallel-bit subsets being is processed, the other 4-bit parallel-bit subsets can start their computations, allowing overlapping and parallelization of the processing steps. This improves the overall efficiency and throughput of the DCIM greatly. Specifically, by adding the results obtained from processing the 4-bit parallel-bit subsets and the weight together, the timing can be improved compared to calculating the result of the entire 12-bit parallel input in one step. The pipelined nature of the proposed DCIM macro design allows for a more efficient use of hardware resources and enables faster processing. To put it simply, a bit-parallel DCIM macro using a pipelined ALU offers improved efficiency, better timing, and reduced design costs for peripheral circuitry. This approach enables the DCIM to achieve the same computing power while optimizing the processing flow and resource utilization.

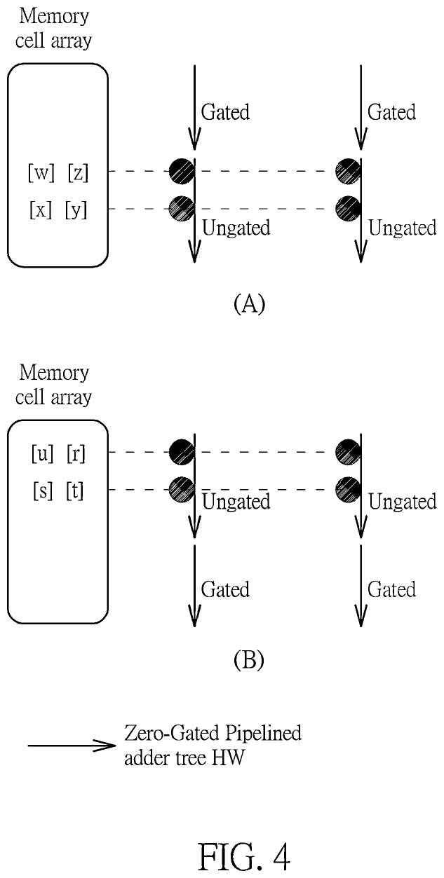

In addition to normal convolution, other convolution operations (e.g., depthwise convolution and 1×1 convolution) may be common in CNN models. Considering a case where a 72 (3×3×8) ic/8 oc/576 MAC DCIM macro is used to deal with depthwise convolution with filter size=3×3, ic=8 and oc=8, only 9 out of 72 operations are valid, while the remaining 63 operations multiple the input activation by zero (i.e., W[i,j]=0, where i=10˜72 and j=1˜8). Considering another case where a 72 (3×3×8) ic/8 oc/576 MAC DCIM macro is used to deal with 1×1 convolution with filter size=1×1, ic=8 and oc=8, only 8 out of 72 operations are valid, while the remaining 64 operations multiple the input activation by zero (i.e., W[i,j]=0, where i=9˜72 and j=1˜8). This leads to wasted power consumption and memory cell resources. To address this issue, the present invention proposes a cell output t selection scheme for gating memory outputs of unnecessary memory cells (i.e., memory cells each storing a weight value set by zero for a specific convolution type). For example, the adder tree circuit 108 is equipped with gating functions, and the COS circuit 106 generates a gating control setting CTRL to pipelined zero-gated adder trees 110 included in the adder tree circuit 108. Specifically, the COS circuit 106 sets the gating control setting CTRL to enable only a portion of memory cells in the memory cell array 102 to provide memory outputs to the adder tree circuit 108 for accumulation. FIG. 4 is a diagram illustrating different cell output selection cases according to an embodiment of the present invention. As shown in sub-diagram (A) of FIG. 4, weight values stored at memory cells [w] and [x] are selected and multiplied with activation values for outputting a result that is allowed to be accumulated for producing the output channel och[j−1], and weight values stored at memory cells [z] and [y] are selected and multiplied with activation values for outputting a result that is allowed to be accumulated for producing the output channel och[j]. As shown in sub-diagram (B) of FIG. 4, weight values stored at memory cells [u] and [s] are selected and multiplied with activation values for outputting a result that is allowed to be accumulated for producing the output channel och[k−1], and weight values stored at memory cells [r] and [t] are selected and multiplied with activation values for outputting a result that is allowed to be accumulated for producing the output channel och[k].

In this embodiment, the COS circuit 106 is further configured to determine selection of the portion of memory cells according to a convolution type of convolution operations applied to the activation input of the bit-parallel DCIM macro 100. For example, a row selection and operation type selection circuit (labeled by “row selection & OP type select”) 10 is configured to control row switching in the memory cell array 102 with multiple rows (e.g., 18 rows or 24 rows), and is further configured to determine an operation type (i.e., a convolution type of convolution operations to be applied to the activation input of the bit-parallel DCIM macro 100). The row selection and operation type selection circuit 10 may inform the COS circuit 106 of the convolution type through a memory interface 14. Hence, the COS circuit 106 can refer to the convolution type to adjust the gating control setting CTRL dynamically. The bit-parallel DCIM macro 100 is an operation friendly DCIM macro. In a case where the operation type is indicative of depthwise convolution using a 3×3 filter, the COS circuit 106 can selectively choose only 9 memory cells for computation. These selected memory cells correspond to the weight and activation values that are multiplied and added to produce 8 output channels. This allows for efficient utilization of memory cells and prevents wastage of power consumption. Similarly, in another case where the convolution type is indicative of 1×1 convolution using 1×1 filter, the COS circuit 106 can be controlled accordingly. By selectively choosing only 8 memory cells associated with the desired weight and activation values, the multiplication and addition process can be performed to produce 8 output channels. By leveraging the selective computation capabilities controlled by the COS circuit 106, depthwise convolution and other operations can be effectively performed with optimal memory utilization and reduced power consumption.

In summary, the present invention proposes a DCIM macro which receives parallel bits and converts/distributes the parallel bits to provide sub-parallel bits for further processing, uses a pipelined ALU to process sub-parallel bits and accumulate the results, uses a COS circuit and pipelined segmented/zero-gated adder trees to do the CNN operation, and/or dynamically controls the COS circuit through a memory interface to do different types of CNN operation.

The proposed bit-parallel DCIM macro design has several advantages compared to the traditional bit-serial DCIM macro design. Since the proposed bit-parallel DCIM macro receives parallel bits, the utilization rate in low-dimensional channel CNN models can be improved. Hence, the proposed bit-parallel DCIM macro can operate with high performance in scenarios where the traditional bit-serial approach may not be effective.

The traditional low-power consumption DCIM macros with bit-serial circuitry suffer from low computation efficiency, leading to the need for combining multiple DCIM macros to achieve the required application computing power. This results in increased peripheral circuitry, wastage of cost, and higher power consumption. The proposed bit-parallel DCIM macro converts the parallel input into multiple parallel-bit subsets and processes the parallel-bit subsets by a pipelined ALU. By adopting this approach, the timing requirements can be met while simultaneously increasing computation performance. This also eliminates the need to combine multiple DCIM macros and alleviates the increase in peripheral circuitry, which reduces cost waste and power consumption.

Furthermore, with the help of the proposed COS scheme, the convolution operations can be effectively performed with optimal memory utilization and reduced power consumption. The COS circuit can allow for dynamic selection and utilization of memory cells based on the specific requirements of the convolution operation being performed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital compute-in-memory (DCIM) macro comprising:
a memory cell array, configured to store weight data of a neural network; and
an arithmetic logic unit (ALU), configured to receive parallel bits of a same input channel in an activation input, and generate a convolution computation output of the parallel bits and target weight data in the memory cell array.

2. The DCIM macro of claim 1, wherein the parallel bits comprise a plurality of parallel-bit subsets, and the ALU is a pipelined ALU configured to generate the convolution computation output by processing the plurality of parallel-bit subsets independently, where processing of the plurality of parallel-bit subsets overlap in a time domain.

3. The DCIM macro of claim 1, further comprising:
a cell output selection circuit, configured to enable only a portion of memory cells in the memory cell array to provide memory outputs to an adder tree circuit of the ALU.

4. The DCIM macro of claim 3, wherein the cell output selection circuit is further configured to determine selection of the portion of memory cells according to a convolution type of convolution operations applied to the activation input.

5. The DCIM macro of claim 4, wherein the convolution type is depthwise convolution.

6. The DCIM macro of claim 4, wherein the convolution type is 1×1 convolution.

7. A digital compute-in-memory (DCIM) method comprising:
storing weight data of a neural network into a memory cell array;
receiving parallel bits of a same input channel in an activation input; and
generating a convolution computation output of the parallel bits and target weight data in the memory cell array.

8. The DCIM method of claim 7, wherein the parallel bits comprise a plurality of parallel-bit subsets, and generating the convolution computation output of the parallel bits and the target weight data in the memory cell array comprises:
generating the convolution computation output by processing the plurality of parallel-bit subsets independently, where processing of the plurality of parallel-bit subsets overlap in a time domain.

9. The DCIM method of claim 7, further comprising:
enabling only a portion of memory cells in the memory cell array to provide memory outputs for accumulation.

10. The DCIM method of claim 9, further comprising:
determining selection of the portion of memory cells according to a convolution type of convolution operations applied to the activation input.

11. The DCIM method of claim 10, wherein the convolution type is depthwise convolution.

12. The DCIM method of claim 10, wherein the convolution type is 1×1 convolution.
